(19) United States
(12) Patent Application Publication
(10) Pub. No.: US 2026/0023976 A1
(43) Pub. Date: Jan. 22, 2026

(54) EVALUATING ELECTRONIC SUBMISSIONS USING GENERATIVE ARTIFICIAL INTELLIGENCE

(71) Applicant: INTUIT INC., Mountain View, CA (US)

(72) Inventors: John SAMUEL, Banglore (IN); Gokul ELUMALAI, Bangalore (IN); Chandrakanth SIVARAMAN, Bengaluru (IN); Proma MUKHERJEE, Bengaluru (IN); Ronny SUSANTO, Plano, TX (US); Srivathsal VENKATARAMU, Bangalore (IN); Sandeep MEWARA, Bangalore (IN); Sanjay KUMAR, Bangalore (IN)

(21) Appl. No.: 18/774,269

(22) Filed: Jul. 16, 2024

(51) Int. Cl. G06N 3/09

(52) U.S. Cl. CPC G06N 3/09

(57) ABSTRACT

Aspects of the present disclosure relate to automated evaluation of electronic datasets. Embodiments include receiving one or more rules related to evaluation of electronic datasets. Embodiments further include generating, via an embedding model, embedding representations of the one or more rules. Embodiments further include receiving an electronic dataset. Embodiments further include identifying a rule that is applicable to the electronic dataset based on using a machine learning model configured to search the embedding representations of the one or more rules based on the electronic dataset. Embodiments further include evaluating, using the machine learning model or an additional machine learning model, the electronic dataset based on the identified rule. Embodiments further include using the machine learning model or the additional machine learning model to generate an evaluation summary for the electronic dataset based on determining that an item within the electronic dataset does not comply with the identified rule.

### INTRODUCTION

Aspects of the present disclosure relate to techniques for automatic evaluation of electronic datasets. In particular, techniques described herein involve identifying relevant rules for a dataset and evaluating the dataset based on embedding representations of rules.

### BACKGROUND

Every year, millions of people, businesses, and organizations around the world use software applications for building and processing electronic datasets. For example, a given software application may be used to complete and submit datasets such as forms, tax returns, product orders, job applications, and/or the like.

However, creating a computing system that allows for seamless automated submission and processing of datasets presents many technical challenges. User submissions may, for instance, contain errors, omissions, incorrectly formatted data, and/or the like that prevent the software application from processing the submission or cause the software application to incorrectly process the submission. To prevent such errors, a software application may, for example, contain manually-written software code that defines acceptable ranges, formats, etc. for a submission and does not allow a user to submit a dataset until the submission complies with the requirements. Effectively writing and implementing such code may, however, require an extensive amount of time and resources. Furthermore, for submissions that involve rule sets that are large and/or frequently modified, manually updating software application code to ensure compliance with the rules may be impractical and prone to errors.

Thus, there is a need in the art for improved methods of evaluating electronically submitted datasets.

### BRIEF SUMMARY

Certain embodiments provide a method of automatic electronic dataset evaluation. The method generally includes: receiving one or more rules related to evaluation of electronic datasets; generating, via an embedding model, embedding representations of the one or more rules; receiving an electronic dataset; identifying a rule that is applicable to the electronic dataset based on using a machine learning model configured to search the embedding representations of the one or more rules based on the electronic dataset; and evaluating, using the machine learning model or an additional machine learning model, the electronic dataset based on the identified rule.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automated electronic dataset evaluation.

FIG. 2 depicts additional example computing components related to automated electronic dataset evaluation.

FIG. 3 depicts example operations related to automated electronic dataset evaluation.

FIG. 4 depicts an example of a processing system for automated electronic dataset evaluation.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automatically evaluating electronically submitted datasets.

According to certain embodiments, one or more rules for datasets may be provided, and embedding representations of the rules may be created. The embedding representations may be stored in a vector store. A user may submit an electronic dataset, and a machine learning model may identify one or more rules (e.g., from the vector store) that are relevant to the dataset. The same or a different machine learning model may evaluate the dataset based on the embedding representations of the rules to determine whether the dataset complies with the rules. One or more actions may be taken based on the evaluation. For instance, a machine learning model may generate an evaluation summary based on the results of the evaluation.

Electronic datasets generally include any form of data that corresponds to a user submission. An electronic dataset may comprise a file, such as an extensible markup language (XML) file. As an example, for a user of a tax filing software, an electronic dataset may be a file that contains a user's tax filing submission (e.g., which may include data such as income and expense values).

In some embodiments, one or more rules related to evaluation of electronic datasets may be received. The rules may be any form of written information in an electronic format such as a file. As an example, rules may be provided to a submission evaluation system as portable document format (PDF) documents or other file types. Rules generally relate to requirements and/or recommendations for electronic datasets. For example, a rule may specify a range within which a value within a dataset should fall. As another example, a rule may specify a format for either a dataset or a component of a dataset (e.g., a file format for an attachment that is included with the submission). Rules may also specify additional information that is required or recommended based on information within a dataset.

Certain embodiments provide that embedding representations may be generated for each provided rule. An embedding generally refers to a vector representation of an entity that represents the entity as a vector in n-dimensional space such that similar entities are represented by vectors that are close to one another in the n-dimensional space. Embeddings may be generated through the use of an embedding model, such as a neural network or other type of machine learning model that learns a representation (embedding) for an entity through a training process that trains the neural network based on a data set, such as a plurality of features of a plurality of entities. The embedding representations of the rules may be added to a vector store.

In some embodiments, the embedding model is trained through a supervised learning process that involves evaluating a training dataset. The training data for the supervised learning process may include datasets that are labeled based on whether the datasets satisfy a set of rules. Embedding representations of the rules may be generated. If a variance exists between a ground truth label and a determination as to whether a rule was satisfied, the embedding model may be retrained. For example, if a ground truth label indicates that a rule was satisfied, but a machine learning model determines that the rule was not satisfied based on the embedding representation of the rule, this may indicate that the embedding representation contains errors or otherwise needs refinement. Thus, one or more parameters of the embedding model may be updated. Certain embodiments provide that the machine learning model that identifies rules and determines whether the rules are satisfied may be trained through a similar supervised learning process (e.g., using embedding representations of rules that are confirmed to be accurate, such that any variance may not be attributed to the embeddings).

According to some embodiments, a rule that is applicable to a submitted electronic dataset may be identified based on the contents of the dataset. As an example, a dataset may be submitted to a machine learning model that is trained to identify rules based on datasets and embedding representations of rules. The machine learning model may search a vector store that stores embedding representations of rules. The searching may be based on one or more tokens within the dataset. For example, the machine learning model may be trained to process embeddings in order to identify an embedding that relates to one or more tokens within the dataset, such as by using a semantic similarity algorithm (e.g., a nearest neighbor algorithm) to identify rules that are most closely related to a given dataset. When such a machine learning model is provided with a dataset as input, the machine learning model may identify rules that are relevant to the dataset based on the embedding representations of the rules. In some embodiments the machine learning model does not itself search the vector store, but is provided with embeddings of rules from the vector store along with the dataset, and the machine learning model compares the dataset (e.g., embeddings of tokens from the dataset) to the embeddings of rules (e.g., using semantic similarity) to identify one or more rules that are relevant to the dataset.

In certain embodiments, the dataset may be evaluated based on the identified rule. The evaluation may comprise determining whether an item within the dataset complies with the rule. For example, the machine learning model may be trained to understand the requirements of the rule based on the embedding representation of the rule. The machine learning model may be trained to check whether the dataset complies with the rule. As an example, the machine learning model may interpret an embedding representation of a rule that requires a value to be present in a certain field of the dataset. The machine learning model may then determine whether a value is present within the field.

Some embodiments provide that one or more actions may be taken based on the results of the evaluating. For example, a dataset may be processed based on a confirmation that the dataset complies with the rules. A dataset may not be processed based on a confirmation that the dataset does not comply with one or more of the rules (e.g., a rule associated with an indication that the rule is mandatory). An evaluation summary may be generated that provides suggestions/instructions to a user based on the evaluating. The evaluation summary may be generated by a machine learning model (e.g., a generative machine learning model) that is trained to generate evaluation summaries based on rules that were not satisfied by the dataset. For example, when provided with a rule that was not satisfied by a dataset, the machine learning model may generate a natural language evaluation summary that provides a user with guidance on how to correct the dataset.

According to some embodiments, user feedback may be received. For example, the feedback may be received based on the evaluation summary provided to the user or based on an indication that a rule was not satisfied. The feedback may be in the form of natural language feedback, a response to a multiple choice question, and/or the like.

In some embodiments, the feedback may be used to update the vector store. For example, an embedding representation of the feedback may be generated and inserted into the vector store. The embedding representation may be used as a rule (e.g., the feedback may include a requirement for datasets, and subsequent datasets may be evaluated based on their compliance with this requirement). As another example, one or more existing rules may be updated based on the user feedback. For example, the feedback may comprise an indication of a requirement that contradicts an existing rule, and this existing rule may be altered based on the feedback.

Certain embodiments provide that the feedback may be used to retrain one or more machine learning models. For example, the feedback may be used to retrain the embedding model and/or the machine learning model(s) that identify rules and/or evaluate datasets. For example, if feedback indicates that an incorrect rule (e.g., a rule that was irrelevant to the dataset) was identified, the embedding model and/or the machine learning model that identifies rules and evaluates datasets may be retrained. As another example, if the user feedback indicates that an embedding of a rule contains errors (e.g., the embedding model generated an embedding representation of a rule that deviated from the actual rule), the embedding model may be retrained. Also, the machine learning model that generates evaluation summaries may be retrained based on user feedback (e.g., feedback that indicates that the evaluation summary is not helpful, not readable, and/or the like).

Embodiments of the present disclosure provide numerous technical and practical effects and benefits. For instance, embodiments of the present disclosure allow for an electronic submission system that may be updated automatically based on a provided set of rules. Because embedding representations of the provided rules are created and used by a machine learning model to evaluate datasets (e.g., based on retrieving a rule indicated by the content of the dataset), the amount of code required to implement the submission system may be drastically reduced. Reducing the amount of required code may improve the efficiency and functioning of computing systems associated with the submission system. For instance, a lower amount of computing resources will be required to store and process the submission system and fewer manual errors may be made because less manually written code is required.

Additionally, embodiments of the present disclosure drastically increase the speed at which submission systems may be updated. As discussed above, while existing techniques for implementing and updating submission systems involve manually coding rules for datasets into a software application, embodiments disclosed herein allow for automatically implementing and updating rules based on providing the rules to the system (e.g., such as by uploading a document that contains the rules). Thus, the submission system may be updated and implemented in real time, as opposed to manual implementation, which can require an extensive amount of manual coding and testing. As a result, submission systems that incorporate embodiments of the present disclosure may be promptly and efficiently updated even for submissions that involve a large set of frequently-changed rules (e.g., submissions for an income tax filing software application, which may involve rules that are based on tax laws and regulations that are frequently changed).

Furthermore, techniques described herein enable efficient and accurate automated evaluation of an electronic dataset, thereby allowing such automated evaluation to be performed at critical points in a software application, such as prior to an electronic dataset being submitted to an endpoint or otherwise processed by one or more components that may not be configured to handle erroneous or noncompliant datasets. Thus, through the use of particular machine learning based techniques described herein, the quality of electronic datasets may be improved, submission errors may be avoided, and application errors or failures may be avoided.

### Example of Computing Components Related to Automated Evaluation of Electronically Submitted Datasets

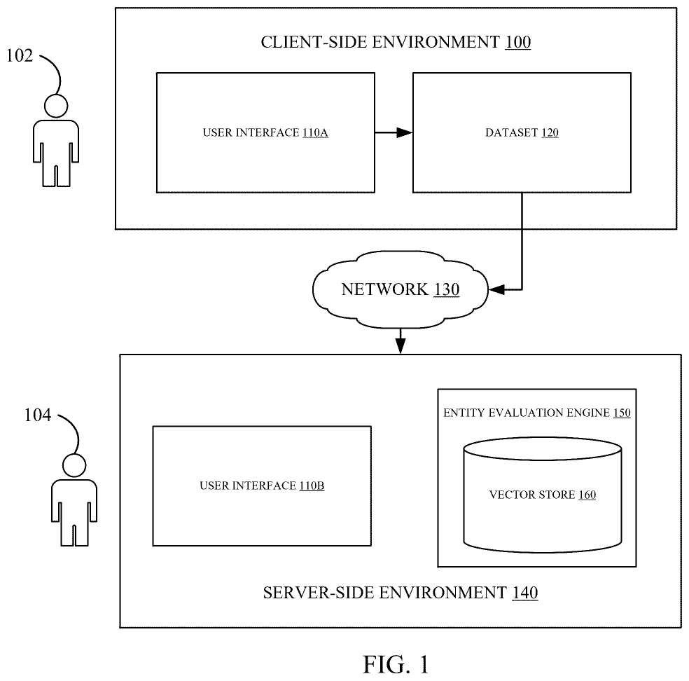

FIG. 1 depicts an example of computing components related to automatic evaluation of electronically submitted datasets.

In a client-side environment 100, a client-side user 102 may interact with an electronic submission system through a user interface 110A. The user interface 110A may allow the client-side user 102 to submit a dataset 120 over a network 130, such as a cloud computing network or any connection over which data may be transmitted. In an example embodiment, the client-side environment 100 may be the client side of a tax preparation software application. The client-side user 102 may be a user of the tax preparation software application. The dataset 120 may be a file that contains the client-side user's submission to the application. This dataset 120 may thus be used to prepare an income tax return for the client-side user 102.

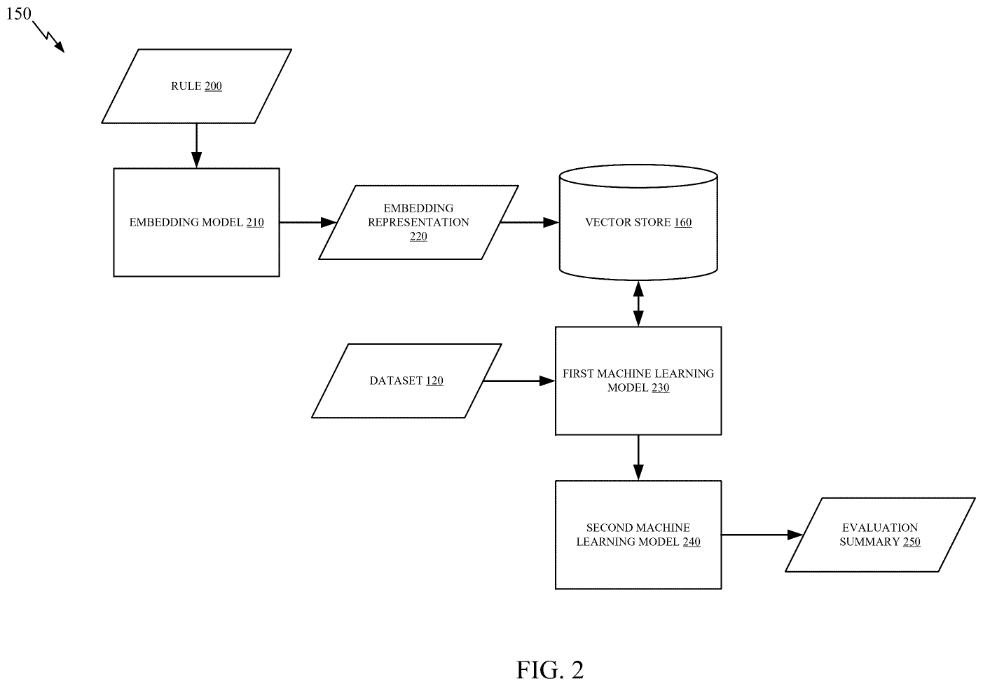

The dataset 120 submitted by the client-side user 102 may be provided to a server-side environment 140 for processing. A server-side user 104 may provide one or more rules for datasets 120 via a server-side user interface 110B. As discussed in further detail below with respect to FIG. 2, the rules may specify requirements and/or recommendations for datasets such as format, a range within which a value should fall, and/or the like. The rules may be provided to the server-side user interface 110B in any written electronic format (e.g., the rules may be typed into a field of user interface 110B, provided as a file such as a PDF, and/or the like). In an example embodiment, the server-side environment 140 may be the server side of a tax preparation software application. The server-side user 104 may be a user that maintains the tax preparation software application. The dataset 120 may be evaluated based on rules provided by the server-side user 104.

As discussed in further detail below with respect to FIG. 2, the rules may be provided to dataset evaluation engine 150. Dataset evaluation engine 150 may generate embedding representations of the rules. The embedding representations may be stored in a vector store 160. Dataset evaluation engine 150 may use the embedding representations of rules within the vector store 160 to evaluate datasets 120. One or more actions may be taken based on the evaluation. For example, the dataset 120 may be processed/accepted if the evaluation indicates that the dataset 120 complies with the rules, an indication may be provided to the client-side user 102 if the dataset 120 does not comply with the rules (e.g., and a determination may be made, either automatically or manually, not to process and/or accept the dataset 120 if the dataset 120 does not comply with one or more of the rules), and/or the like. In some embodiments, an evaluation summary may be generated and provided to the client-side user 102 based on the evaluation. As an example, the evaluation summary may provide the client-side user 102 with instructions for correcting the dataset 120. Certain embodiments provide that the client-side user 102 and/or the server-side user 104 may provide feedback based on the results of the evaluation, such as via a user interface 110.

FIG. 2 depicts an additional example of computing components related to automatic evaluation of electronically submitted datasets. In particular, FIG. 2 shows dataset evaluation engine 150 of FIG. 1 in greater detail.

As discussed above with respect to FIG. 1, a rule 200 may be provided to dataset evaluation engine 150. The rule 200 may be provided in any written electronic format, such as a file. The rule 200 may comprise constraints and/or recommendations for datasets 120. For example, a rule 200 may indicate a format for the dataset or any data therein. A rule 200 may indicate a type of character for an input to a dataset 120, a range for a value within a dataset 120, and/or the like. The rule 200 may be conditional. For example, if a given value is present within a field of the dataset, the rule 200 may require that another field within the dataset be completed. In an example embodiment where the submission is associated with a tax filing software application, the rules 200 may be based on tax laws and/or regulations. For example, a rule 200 may state “if the filing status of a return is married filing jointly, then the field ‘SpouseSSN’ must have a value.”

Rules 200 may comprise requirements, recommendations, and/or the like. If a rule is a requirement instead of, for example, a recommendation, a dataset 120 may not be accepted and/or submitted to an endpoint until the rule 200 is complied with. If a rule is a recommendation instead of, for example, a requirement, a user may be provided with an indication of the recommendation and may choose whether to submit the dataset 120 in light of the recommendation or to modify the dataset 120 to comply with the recommendation prior to submission.

Rule 200 may be provided to an embedding model 210, which may generate an embedding representation 220 of the rule 200. The embedding model 210 may comprise a machine learning model configured to generate embedding representations 220 of entities such as rules 200. An embedding generally refers to a vector representation of an entity that represents the entity as a vector in n-dimensional space such that similar entities are represented by vectors that are close to one another in the n-dimensional space. The embedding model 210 may comprise a neural network or other type of machine learning model that learns a representation (embedding) for an entity through a training process that trains the neural network based on a data set, such as a plurality of features of a plurality of entities. In one example, the embedding model comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Word2Vec and GloVe embeddings. These are included as examples, and other techniques for generating embedding representations 220 of rules are possible.

The embedding representation 220 may be provided to a vector store 160. In some embodiments, an embedding representation of user feedback (e.g., from client-side and/or server-side users as discussed above with respect to FIG. 1) may be created and provided to the vector store 160. For example, a user's selection regarding a multiple choice question or an embedding representation of natural language feedback may be included in the vector store 160. An embedding representation of user feedback may be used as a rule (e.g., the feedback may indicate a requirement or recommendation for datasets 120).

The dataset 120 may be provided to a first machine learning model 230. As discussed above, a dataset 120 may comprise a file, such as a markup language (e.g., extensible markup language) file. The first machine learning model 230 may search the embedding representations stored in the vector store 160 based on tokens within the dataset 120. For example, the first machine learning model 230 may be trained to identify rules based on finding an embedding representation that is related to one or more tokens within the dataset 120 (e.g., based on using a semantic similarity algorithm such as a nearest neighbor algorithm). In some embodiments, the first machine learning model 230 (or the embedding model 210) generates embeddings of tokens in within the dataset 120 and the first machine learning model 230 compares the embeddings of the tokens to the embeddings of rules stored in vector store 160. The first machine learning model 230 (or a different machine learning model) may use the identified rules to evaluate the dataset 120. For example, the first machine learning model 230 may interpret an embedding representation of a rule and evaluate the dataset 120 based on the interpretation (e.g., determine whether the dataset 120 satisfies the identified rule).

The embedding model 210 and/or the first machine learning model 230 may be trained through a supervised learning process. Supervised learning techniques generally involve providing training inputs to a machine learning model. The machine learning model processes the training inputs and outputs predictions based on the training inputs. The predictions are compared to the known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the outputs produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and/or the like. In some embodiments, validation and testing are also performed for a machine learning model, such as based on validation data and test data, as is known in the art.

The training data for the supervised learning process involving the embedding model 210 may include datasets that are labeled based on whether the datasets satisfy a set of rules. Embedding representations of the rules may be generated. If a variance exists between a ground truth label and a prediction as to whether a rule was satisfied (e.g., a prediction made by the first machine learning model 230 based on an embedding representation of the rule generated by embedding model 210), the embedding model 210 may be retrained. For example, if a ground truth label indicates that a rule was satisfied, but the first machine learning model 230 determines that the rule was not satisfied based on the embedding representation of the rule, this may indicate that the embedding representation contains errors or otherwise needs refinement. Thus, the embedding model 210 may be retrained and/or one or more parameters of the embedding model 210 may be updated. As an example, weights of the embedding model 210 may be adjusted and/or the granularity of the embeddings may be adjusted (e.g., such that each embedding covers a larger or smaller number of characters).

The first machine learning model 230 may be trained through a similar supervised learning process. For example, embedding representations of rules that are confirmed to be accurate may be used, and the first machine learning model 230 may be retrained based on any variance between a prediction made by the first machine learning model 230 and the ground truth labels. For example, the training may comprise iteratively adjusting weights of the model until a cost function is minimized.

The results of the evaluation (e.g., an indication of one or more rules that were not satisfied) may be provided to a second machine learning model 240. The second machine learning model 240 may be a language processing machine learning model such as a Large Language Model (LLM). The second machine learning model 240 may be trained and/or otherwise configured to generate an evaluation summary 250 based on the evaluation. The evaluation summary 250 may comprise natural language instructions, suggestions, indications, and/or the like that help a user understand and/or correct problems with the dataset 120. For example, if the dataset 120 does not comply with a rule, the evaluation summary 250 may tell a user that the dataset 120 does not comply with the rule (e.g., the evaluation summary 250 may indicate one or more rules that the dataset 120 violates) and/or provide the user with instructions and/or tips for correcting the dataset 120. Other actions may be performed based on the evaluation as well, such as accepting a submission (e.g., based on the dataset 120 complying with the rules), rejecting a submission (e.g., based on the dataset 120 not complying with the rules), indicating the compliance/non-compliance of the dataset 120 to a user without generating an evaluation summary 250, and/or the like. In some embodiments, the second machine learning model 240 is provided with the results of the evaluation by the first machine learning model 230 (e.g., an indication of one or more rules that were not satisfied) and a prompt instructing the second machine learning model 240 to generate a natural language summary of the results and, in some embodiments, to generate natural language instructions, suggestions, indications, and/or the like that help a user understand and/or correct problems with the dataset 120. The second machine learning model 240 may generate the evaluation summary 250 in response to such a prompt.

As discussed above with respect to FIG. 1, user feedback may be received based on the results of the evaluation (e.g., from server-side user, or from a client-side user based on an evaluation summary 250). The feedback may comprise natural language feedback, a selection of a multiple choice answer to a question regarding the accuracy of the dataset evaluation engine 150, and/or the like. One or more machine learning models (e.g., embedding model 210, first machine learning model 230, and/or second machine learning model 240) may be retrained based on the user feedback. For example, the user feedback may be used as a ground truth label in a supervised learning process as described above.

### Example Operations Related to Automated Electronic Dataset Evaluation

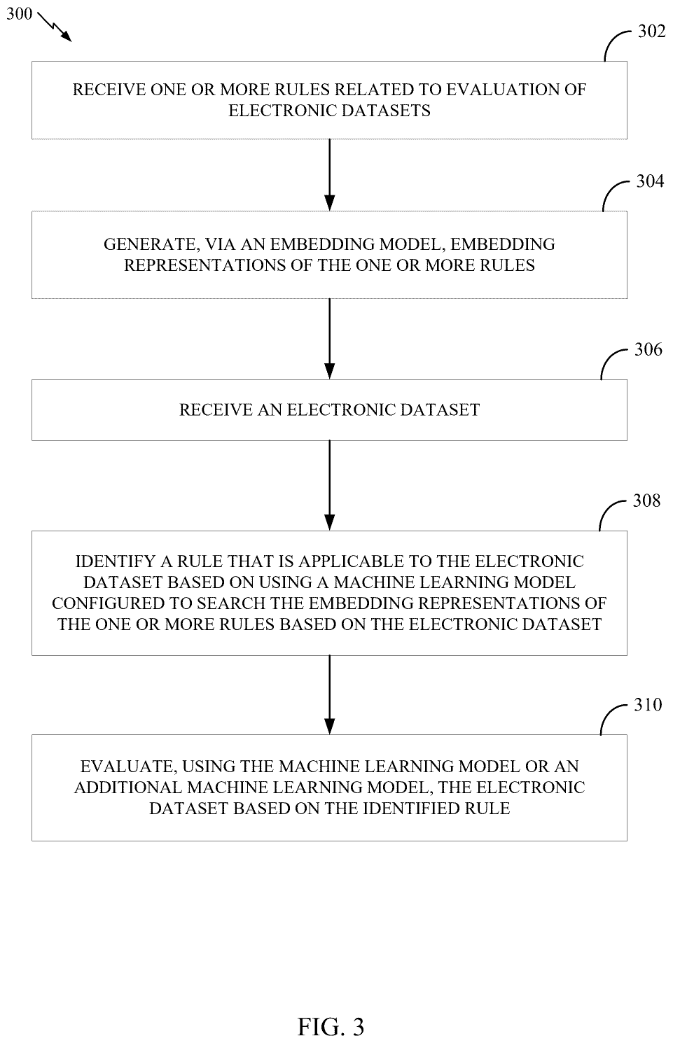

FIG. 3 depicts example operations 300 related to automated electronic dataset evaluation. For example, operations 300 may be performed by one or more of the components described in FIG. 1 or FIG. 2.

Operations 300 begin at step 302 with receiving one or more rules related to evaluation of electronic datasets.

Operations 300 continue at step 304 with generating, via an embedding model, embedding representations of the one or more rules. In some embodiments, the embedding model is trained through a supervised learning process involving evaluating training entities.

Operations 300 continue at step 306 with receiving an electronic dataset. Some embodiments provide that the electronic dataset comprises a markup language file.

Operations 300 continue at step 308 with identifying a rule that is applicable to the electronic dataset based on using a machine learning model configured to search the embedding representations of the one or more rules based on the electronic dataset. Certain embodiments provide that the searching of the embedding representations of the one or more rules based on the electronic dataset is based on a token within the electronic dataset. According to some embodiments, the machine learning model is trained through a supervised learning process involving evaluating training entities. In certain embodiments, the embedding representations of the one or more rules are stored in a vector store, and the searching of the embedding representations of the one or more rules based on the electronic dataset comprises searching the vector store

Operations 300 continue at step 310 with evaluating, using the machine learning model or an additional machine learning model, the electronic dataset based on the identified rule. Some embodiments provide that the evaluating comprises determining that an item within the electronic dataset does not comply with the identified rule.

According to certain embodiments, an evaluation summary may be generated for the electronic dataset based on determining that an item within the electronic dataset does not comply with the identified rule. Certain embodiments provide that user feedback may be received based on the evaluation summary. According to some embodiments, the user feedback may be used to retrain the machine learning model or the additional machine learning model. In certain embodiments, an embedding representation of the user feedback is generated by the embedding model. Some embodiments provide that the machine learning model or the additional machine learning model comprises a language processing machine learning model, and the evaluation summary comprises natural language instructions for correcting the electronic dataset.

### Example of a Processing System for Automated Electronic Dataset Evaluation

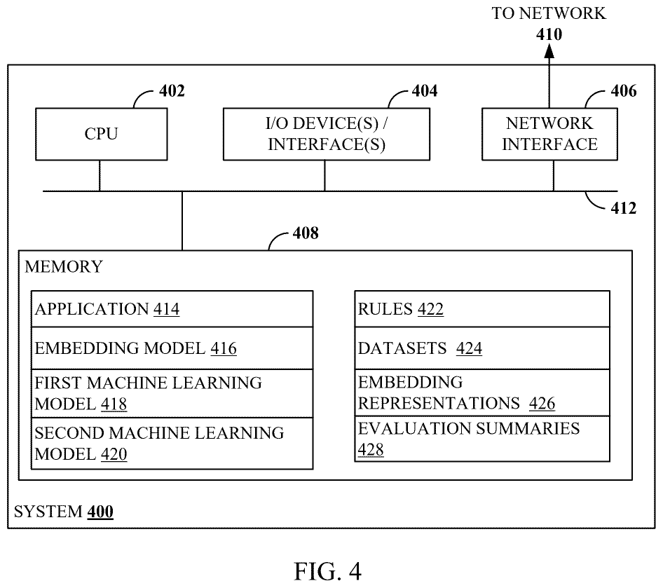

FIG. 4 illustrates an example system 400 with which embodiments of the present disclosure may be implemented. For example, system 400 may be configured to perform operations 300 of FIG. and/or to implement one or more components as in FIG. 1 or FIG. 2.

System 400 includes a central processing unit (CPU) 402, one or more I/O device interfaces that may allow for the connection of various I/O devices 404 (e.g., keyboards, displays, mouse devices, pen input, etc.) to the system 400, network interface 406, a memory 408, and an interconnect 412. It is contemplated that one or more components of system 400 may be located remotely and accessed via a network 410. It is further contemplated that one or more components of system 400 may comprise physical components or virtualized components.

CPU 402 may retrieve and execute programming instructions stored in the memory 408. Similarly, the CPU 402 may retrieve and store application data residing in the memory 408. The interconnect 412 transmits programming instructions and application data, among the CPU 402, I/O device interface 404, network interface 406, and memory 408. CPU 402 is included to be representative of a single CPU, multiple CPUs, a single CPU having multiple processing cores, and other arrangements.

Additionally, the memory 408 is included to be representative of a random access memory or the like. In some embodiments, memory 408 may comprise a disk drive, solid state drive, or a collection of storage devices distributed across multiple storage systems. Although shown as a single unit, the memory 408 may be a combination of fixed and/or removable storage devices, such as fixed disc drives, removable memory cards or optical storage, network attached storage (NAS), or a storage area-network (SAN).

As shown, memory 408 includes application 414, embedding model 416, first machine learning model 418, and second machine learning model 420. In some embodiments, application 414 may be representative of a software application associated with client-side environment 100 of FIG. 1 and used to deliver datasets to server side environment 140 of FIG. 1. Embedding model 416 may be representative of embedding model 210 of FIG. 2. First machine learning model 418 may be first machine learning model 230 of FIG. 2. Second machine learning model 418 may be second machine learning model 240 of FIG. 2.

Memory 408 further comprises rules 422 which may correspond to rule 200 of FIG. 2. Memory 408 further datasets 424, which may correspond to dataset 120 of FIG. 1 or FIG. 2. Memory 408 further comprises embedding representations 426, which may correspond to embedding representation 220 of FIG. 2. Memory 408 further comprises evaluation summaries 428, which may correspond to user interface content 250 of FIG. 2.

It is noted that in some embodiments, system 400 may interact with one or more external components, such as via network 410, in order to retrieve data and/or perform operations.

### ADDITIONAL CONSIDERATIONS

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of automatic electronic dataset evaluation, comprising:
receiving one or more rules related to evaluation of electronic datasets;
generating, via an embedding model, embedding representations of the one or more rules;
receiving an electronic dataset;
identifying a rule that is applicable to the electronic dataset based on using a machine learning model configured to search the embedding representations of the one or more rules based on the electronic dataset; and
evaluating, using the machine learning model or an additional machine learning model, the electronic dataset based on the identified rule.

2. The method of claim 1, wherein the evaluating comprises determining that an item within the electronic dataset does not comply with the identified rule.

3. The method of claim 2, further comprising using the machine learning model or the additional machine learning model to generate an evaluation summary for the electronic dataset based on the determining.

4. The method of claim 3, further comprising receiving user feedback based on the evaluation summary, wherein the user feedback is used to retrain the machine learning model or the additional machine learning model.

5. The method of claim 3, further comprising receiving user feedback based on the evaluation summary, wherein an embedding representation of the user feedback is generated by the embedding model.

6. The method of claim 3, wherein the machine learning model or the additional machine learning model comprises a language processing machine learning model, and wherein the evaluation summary comprises natural language instructions for correcting the electronic dataset.

7. The method of claim 1, wherein the searching of the embedding representations of the one or more rules based on the electronic dataset is based on a token within the electronic dataset.

8. The method of claim 1, wherein the electronic dataset comprises a markup language file.

9. The method of claim 1, wherein the embedding model is trained through a supervised learning process involving evaluating training entities.

10. The method of claim 1, wherein the machine learning model is trained through a supervised learning process involving evaluating training entities.

11. The method of claim 1, further comprising storing the embedding representations of the one or more rules in a vector store, wherein the searching of the embedding representations of the one or more rules based on the electronic dataset comprises searching the vector store.

12. A system for automatic electronic dataset evaluation, comprising:
one or more processors; and
a memory comprising instructions that, when executed by the one or more processors, cause the system to:
receive one or more rules related to evaluation of electronic datasets;
generate, via an embedding model, embedding representations of the one or more rules;
receive an electronic dataset;
identify a rule that is applicable to the electronic dataset based on using a machine learning model configured to search the embedding representations of the one or more rules based on the electronic dataset; and
evaluate, using the machine learning model or an additional machine learning model, the electronic dataset based on the identified rule.

13. The system of claim 12, wherein the evaluating comprises determining that an item within the electronic dataset does not comply with the identified rule.

14. The system of claim 13, wherein the instructions further cause the system to use the machine learning model or the additional machine learning model to generate an evaluation summary for the electronic dataset based on the determining.

15. The system of claim 14, wherein the instructions further cause the system to receive user feedback based on the evaluation summary, wherein the user feedback is used to retrain the machine learning model or the additional machine learning model.

16. The system of claim 14, wherein the machine learning model or the additional machine learning model comprises a language processing machine learning model, and wherein the evaluation summary comprises natural language instructions for correcting the electronic dataset.

17. The system of claim 12, wherein the searching of the embedding representations of the one or more rules based on the electronic dataset is based on a token within the electronic dataset.

18. The system of claim 12, wherein the embedding model is trained through a supervised learning process involving evaluating training entities.

19. The system of claim 12, wherein the machine learning model is trained through a supervised learning process involving evaluating training entities.

20. The system of claim 12, wherein the instructions further cause the system to store the embedding representations of the one or more rules in a vector store, wherein the searching of the embedding representations of the one or more rules based on the electronic dataset comprises searching the vector store.
